(19) United States
(12) Patent Application Publication
(10) Pub. No.: US 2025/0325145 A1
(43) Pub. Date: Oct. 23, 2025

(54) COUPLING ASSEMBLY FOR TILT-HEAD STYLE STAND MIXER

(71) Applicant: WHIRLPOOL CORPORATION, BENTON HARBOR, MI (US)

(72) Inventors: Timothy E. Heater, Hartford, MI (US); Joseph W. Snyder, Benton Harbor, MI (US); Jeremy T. Wolters, Stevensville, MI (US); Benjamin B. Edinger, Grand Haven, MI (US); Michael Johnson, West Olive, MI (US); Michael Stinchcomb, Grand Haven, MI (US)

(73) Assignee: WHIRLPOOL CORPORATION, BENTON HARBOR, MI (US)

(21) Appl. No.: 18/638,272

(22) Filed: Apr. 17, 2024

(51) Int. Cl. A47J 43/08; A47J 43/044

(52) U.S. Cl. CPC A47J 43/082; A47J 43/044; A47J 2043/04481

(57) ABSTRACT

A stand mixer includes a base defining an interior with an opening to the interior and a mixing head being supported over an upper mounting area of the base and defining a mounting tongue extending through the opening to the interior of the base. The stand mixer further includes a coupling assembly including a pin body extending between opposite first and second ends and a pivot frame including first and second support receptacles respectively receiving the first and second ends of the pin body and a frame body connecting the first and second support receptacles. The frame body is secured to the base within the interior thereof, and the pin body is secured to the mounting tongue of the mixing head to pivotably couple the mixing head to the base with the mixing head being rotatable on the base between a lowered position and a raised position.

### BACKGROUND OF THE DISCLOSURE

The present disclosure generally relates to a stand mixer, and more specifically, to a coupling assembly for a tilt-head stand mixer.

So-called tilt head stand mixers typically include a base configured for retaining a mixing bowl and for resting on a work surface. A mixing head is mounted to the base and includes a housing that encloses the motor and drive mechanism associated with the mixer and configured for powering the planetary output of the mixer. The mixing head is typically joined to the base with a joint configured such that the head can be rotated upwards and rearward on a pivot that allows the mixing bowl and/or any mixing implement to be removed from the base or the output, respectively. This joint may be formed by way of a pin that passes through a hole machined through the outer “cheeks” of the base and through a tongue that extends downward from the housing between the cheeks. For various manufacturing processing and tolerance reasons, the fit between the pin and the portions of the hole associated with the various features is not precise and can result in the head exhibiting some degree of yaw and roll, in addition to the desired pitch rotation achieved by the coupling.

### SUMMARY OF THE DISCLOSURE

According to one aspect of the present disclosure, a stand mixer includes a base configured for resting on a surface and defining an interior and an upper mounting area with an opening to the interior and a mixing head being supported over the upper mounting area of the base and defining a mounting tongue extending through the opening in the mounting area to the interior of the base. The stand mixer further includes a coupling assembly including a pin body extending between opposite first and second ends and a pivot frame including first and second support receptacles respectively receiving the first and second ends of the pin body and a frame body connecting the first and second support receptacles. The frame body is secured to the base along the interior thereof, and the pin body is secured to the mounting tongue of the mixing head to pivotably couple the mixing head to the base with the mixing head being rotatable on the base between a lowered, use position and a raised, non-use position with respect to the base.

According to another aspect of the present disclosure, a coupling assembly for a stand mixer includes a pin body extending between opposite first and second ends and being fixedly securable with a tongue of a mixing head of the stand mixer. The coupling assembly further includes a pivot frame having a frame body being securable to a base of the stand mixer within an interior thereof and first and second support receptacles respectively receiving the first and second ends of the pin body such that the pin body is rotatable with respect to the pivot frame. The frame body connects the first and second support receptacles such that the mixing head is rotatable on the base between a lowered, use position and a raised, non-use position with respect to the base.

According to yet another aspect of the present disclosure, a method for assembling a stand mixer includes aligning a mixing head over an upper mounting area of a base configured for resting on a surface and defining an interior. The mounting area includes an opening to the interior, and the mixing head defines a mounting tongue that through the opening in the mounting area. The method further includes positioning a coupling assembly within the interior of the base. The coupling assembly includes a pin body extending between opposite first and second ends and a pivot frame including first and second support receptacles respectively receiving the first and second ends of the pin body and a frame body connecting the first and second support receptacles. The method further includes attaching the mixing head to the base by fixing the frame body to the base along the interior thereof and fixing the pin body to the mounting tongue of the mixing head. The pin body is rotatable within the first and second support receptacles of the pivot frame to pivotably couple the mixing head to the base with the mixing head being rotatable on the base between a lowered, use position and a raised, non-use position with respect to the base.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a stand mixer according to an aspect of the disclosure with a mixing head thereof in a lowered position;

FIG. 2 is a perspective view of the stand mixer with the mixing head in a raised position;

FIG. 3 is a bottom view of the stand mixer in a partially disassembled state showing a coupling assembly for pivotably attaching the mixing head to a base of the stand mixer;

FIG. 4 is a partial cutaway view showing the coupling assembly in a secured state between the mixing head and the base;

FIG. 5 is a cross-section detail view of the stand mixer with the mixing head in the lowered position;

FIG. 6 is a cross-section detail view of the stand mixer with the mixing head in the raised position;

FIG. 7 is a perspective view of an implementation of the coupling assembly;

FIG. 8 is a cross section perspective view of the coupling assembly of FIG. 7;

FIG. 9 is a cross section perspective view showing a step in the assembly of the coupling member with the stand mixer; and

FIG. 10 is a cross section perspective view showing a further step in the assembly of the coupling member with the stand mixer.

The components in the figures are not necessarily to scale, emphasis instead being placed upon illustrating the principles described herein.

### DETAILED DESCRIPTION

The present illustrated embodiments reside primarily in combinations of method steps and apparatus components related to a stand mixer. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

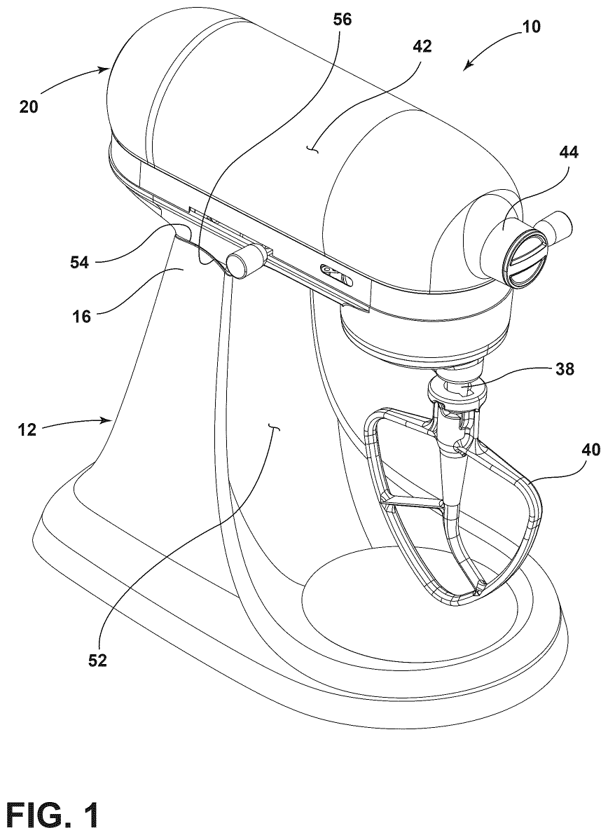

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Ordinal modifiers (i.e., “first”, “second”, etc.) may be used to distinguish between various structures of a disclosed article in various contexts, but such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

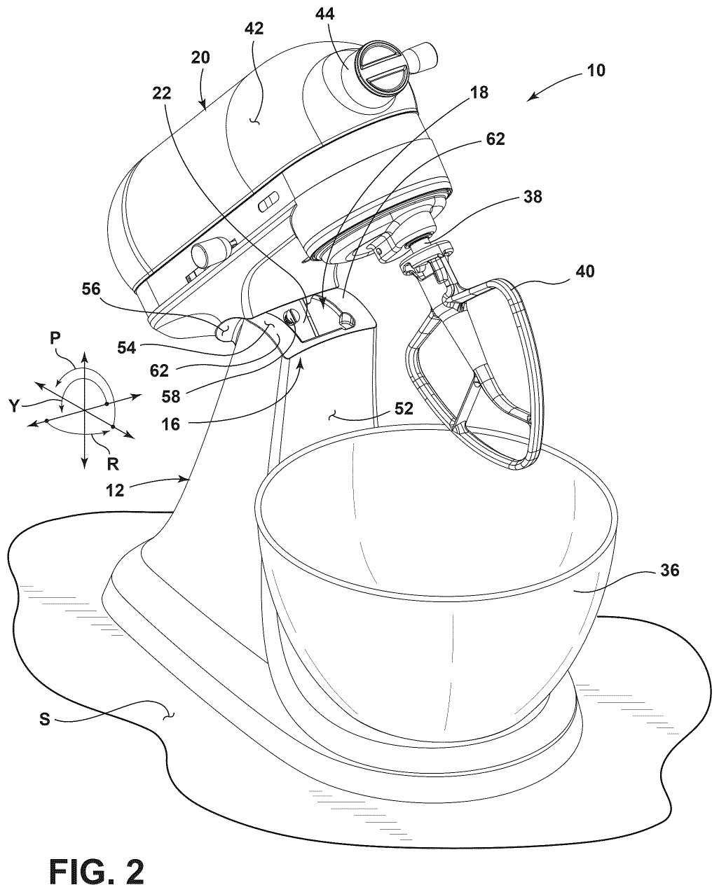

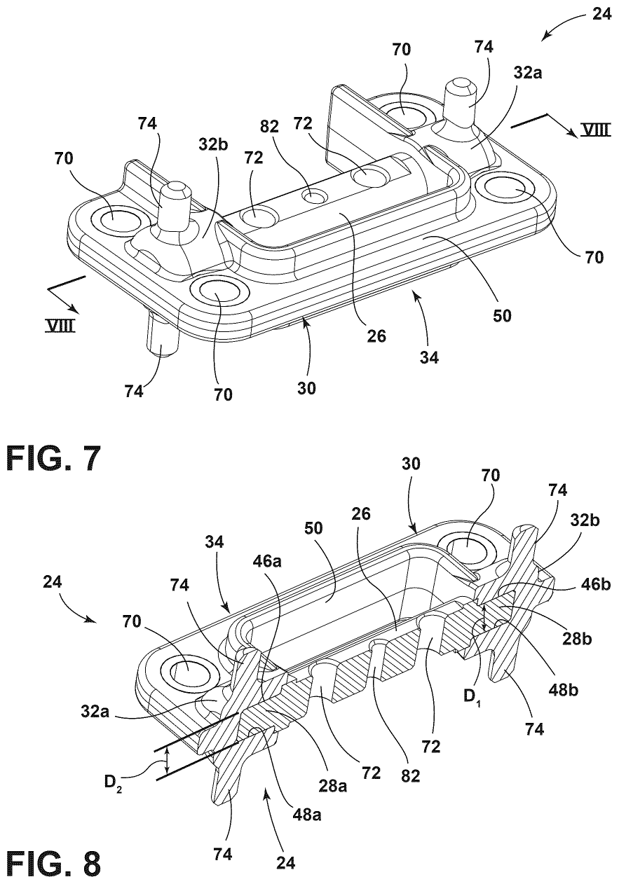

Referring to FIGS. 1-8, reference numeral 10 generally designates a stand mixer. As shown, the stand mixer 10 includes a base 12 configured for resting on a surface and defining an interior 14 and an upper mounting area 16 with an opening 18 to the interior. A mixing head 20 is supported over the upper mounting area 16 of the base 12 and defines a mounting tongue 22 extending through the opening 18 in the mounting area 16 to the interior 14 of the base 12. The stand mixer 10 further includes a coupling assembly 24 including a pin body 26 extending between opposite first and second ends 28a and 28b and a pivot frame 30 including first and second support receptacles 32a and 32b respectively receiving the first and second ends 28a, 28b of the pin body 26 and a frame body 34 connecting the first and second support receptacles 32a, 32b. The frame body 34 is secured to the base 12 along the interior 14 thereof. The pin body 26 is secured to the mounting tongue 22 of the mixing head 20 to pivotably couple the mixing head 20 to the base 12 with the mixing head 20 being rotatable on the base 12 between a lowered, use position (FIG. 1) and a raised, non-use position (FIG. 2) with respect to the base 12.

In general, the stand mixer 10 described herein may be generally configured as an electronic appliance used for mixing ingredients. According to a typical construction, the stand mixer 10 includes a bowl 36 that is anchored or otherwise retained by the mixer 10 at the base 12 thereof. The mixer 10 includes an output 38 that is retained in a fixed position with respect to the bowl 36. Various mixing tools can be connected to the output 38 for use in connection with various ingredients and desired results or purposes. The mixer 10 is configured to drive such tools, including the depicted beater attachment 40, in a planetary motion that involves rotating the mixing tool about a moving axis that rotates about a central fixed axis (that aligns with a center of the mixing bowl 36). This arrangement is used to develop more even incorporation of ingredients during mixing by re-incorporating the ingredients, for example. The mixing bowl 36 is removably coupled with the base 12 such that the beater attachment 40, for example, can mix or otherwise process ingredients contained in the mixing bowl 36. As shown, the beater attachment 40 may be used, in one aspect, to prepare batters, frostings, and other viscous food products that are intended to be thicker in consistency than items processed using a whisk, for example, while not settling into a cohesive mass, as would a dough, for example (which may be processed using a separate element in the form of a hook, for example).

The present stand mixer 10 is what may be generally referred to as a “tilt-head” mixer, in which the mixing head 20 is rotatably fixed about the mounting area 16 of the base 12 by an extent sufficient to move the mixing tool (i.e., beater attachment 40) upwardly out of the bowl 36 such that the tool can be removed or the interior of the bowl 36 can be accessed or removed (such as for addition of ingredients or removal of the mixed product). As shown in FIG. 2, the stand mixer 10 includes the above-mentioned mixing head 20 having a housing 42 connected to base 12, which supports the mixing head 20 above a work surface S. The housing 42 encloses a drive motor that is configured to drive planetary movement of the output 38, as described above, as well as rotating a coupling within the attachment hub 44. In one example, the drive motor can be a variable speed AC motor that can be controlled by a user via a sliding control knob accessible on the exterior of the housing 42. In other examples, the drive motor can be a DC motor, including a brushless DC motor that can be controlled digitally using an adaptation of the control knob or using a digital interface.

The present coupling assembly 24 is configured to provide the above-described upward rotating movement of the mixing head 20 with respect to the base 12, which is illustrated in FIG. 2 as the pitch direction P, minimizing other movement of the mixing head 20 relative to the base 12. In general, the coupling assembly 24 is configured to minimize or appreciably eliminate rotation of the mixing head 20 about the base 12 in the roll R and yaw Y directions, as well as lateral sliding of the mixing head 20 with respect to base 12, that may result from prior coupling arrangements. In one aspect, such movement may be considered appreciably eliminated by making any such movement imperceptible to the user under ordinary circumstances. In this respect, it is noted that the stand mixer 10 may incorporate a locking mechanism between the mixing head 20 and the base 12 that maintains the mixing head 20 in the downward position (FIG. 1) during use, and that the incorporation or use of such a locking mechanism does not limit or restrict the ability of the coupling assembly 24 to facilitate movement between positions, as discussed herein.

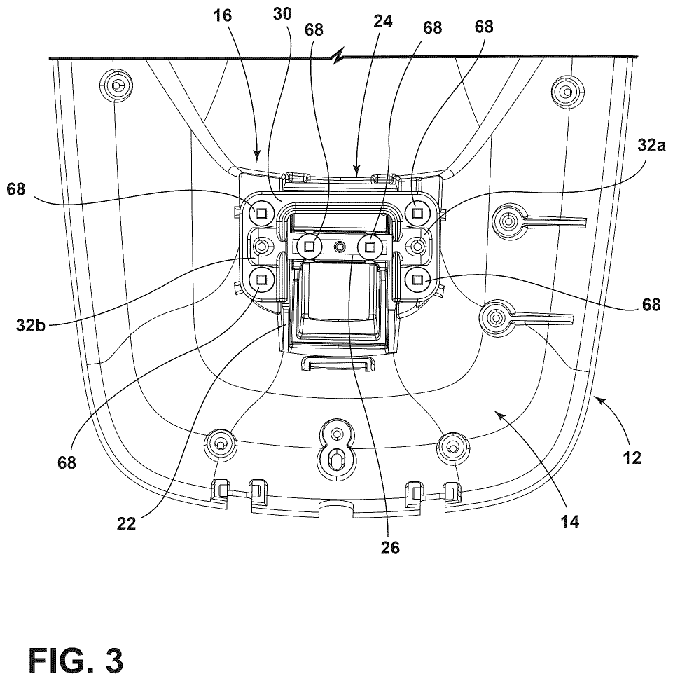

As shown in FIGS. 3-8, in the implementation of coupling assembly 24 described herein, the pin body 26 can be fixed with respect to the tongue 22 of the mixing head 20, and the frame body 34 can be fixed within the interior 14 of the base 12. In this implementation, the pin body 26 is rotatably coupled with the pivot frame 30 to facilitate the desired rotation of the mixing head 20 on the base 12 in the pitch direction P. More specifically, the first and second ends 28a, 28b of the pin body 26 can be defined by respective cylindrical segments 46a and 46b, each having a first external diameter D1. The first and second support receptacles 32a and 32b can define respective cylindrical openings 48a, 48b having a first internal diameter D2 equal to the first external diameter such that the first and second ends 28a, 28b are closely received in the first and second support receptacles 32a, 32b. To reliably achieve the desired close fitting relationship, particularly given the different manufacturing tolerances typically associated with forming the internal and external mating features, the pin body 26 can consist essentially of a metal, such as stainless steel or the like, and the frame body can comprise a plastic, such as polycarbonate (“PC”) or polycarbonate/acrylonitrile-butadiene-styrene terpolymer blend (“PC/ABS”), that is over molded with respect to the pin body 26. In this manner, the cylindrical openings 48a, 48b are formed directly over so as to directly correspond in size and shape with cylindrical segments 46a, 46b such that the first internal diameter D2 is directly defined by way of the first external diameter D1.

The selection of materials and the formation of the components, including the metal material of the pin body 26 which may be extruded into the general shape and machined to derive the various features, including the cylindrical segments 46a, 46b, and the over molding of the pivot frame 30 can maintain the mechanical differentiation between the pin body 26 and the pivot frame 30 and can promote smooth rotational movement of the ends 28a, 28b of the pin body 26 within the support receptacles 32a, 32b. Additionally, the formation of the pivot frame 30 by way of over molding can achieve the specified close fitting arrangement between the cylindrical segments 46a, 46b and the cylindrical openings 48a, 48b, which may, essentially, be a zero-tolerance fitting, such that potential modes of undesired movement, such as in the roll R and yaw Y directions is removed, when the pin body 26 and the pivot frame 30 are fixed to the mounting tongue 22 and the base 12, respectively, as discussed further below. Additionally, the incorporation of the frame body 34, including the central portion 50, as a unitary member with the support receptacles 32a, 32b, maintains the engaged positions of the ends 28a, 28b of the pin body 26 with the support receptacles 32 during transportation and assembly of the coupling assembly 24 with the base 12 and mixing head 20 to provide a close lateral fit that appreciably removes the mode of lateral movement between the mixer head 20 and the base 12 without introducing excess friction therebetween due to lateral compression of the support receptacles 32a, 32b against the ends 28a, 28b.

As can be appreciated, in an aspect of the present disclosure, the coupling assembly 24 discussed in the context of the depicted stand mixer 10 can be adapted according to the principles described herein for use with stand mixers that vary in form or configuration from the illustrated stand mixer 10. In this respect, it is noted that the pin body 26 and the pivot frame can be adapted to be fixedly securable with variations of the tongue 22 of the mixing head 20 depicted in the figures, and the pivot frame 30, including the frame body 34 can be adapted to be securable to variations of the base 12 of the depicted stand mixer 10, including the features within the interior 14 with which the pivot frame 30 is fixed, as discussed further below. Additionally, the structures discussed below with which the coupling assembly 24 is fixed can be adapted to be compatible with variations in the mixing head 20 and the base 12 described in connection therewith in accordance with the spirit of the disclosure. In this respect, it is noted, however, that the specific features of the stand mixer 10 discussed herein may form additional aspects of the inventive disclosure.

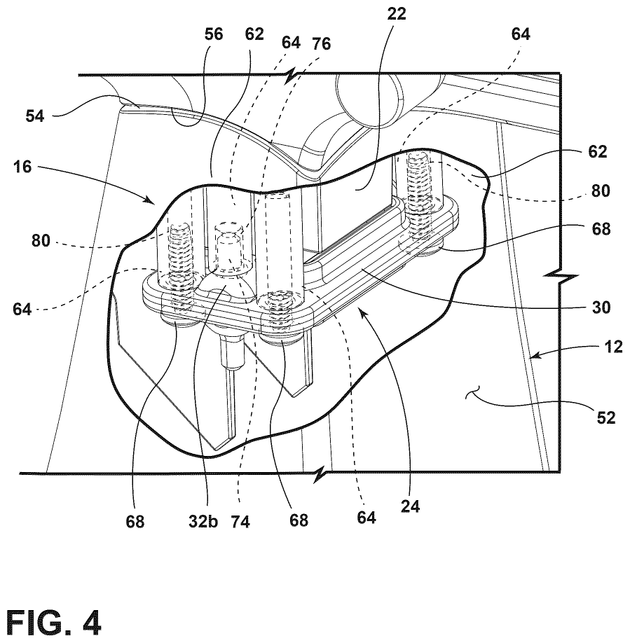

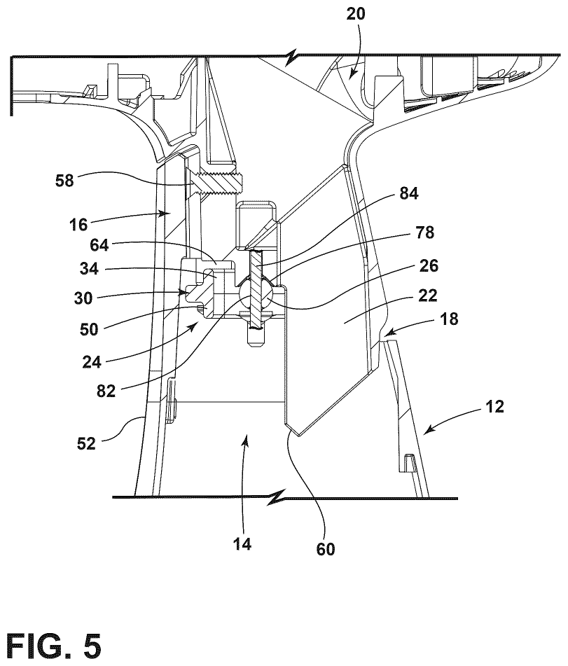

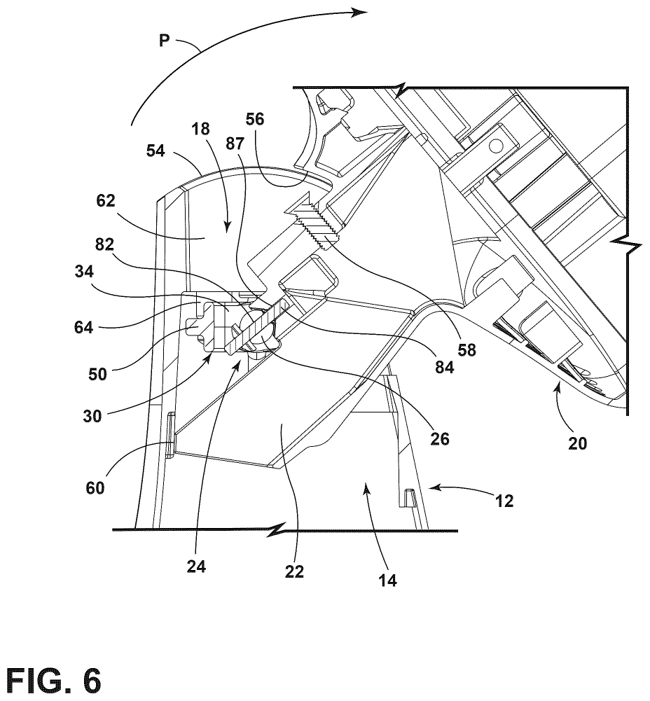

Returning to FIGS. 4-8, the pivot frame 30 can be a unitary structure incorporating the support receptacles 32a, 32b with the frame body 34, which, as discussed above, includes central portion 50. In the depicted implementation, the central portion 50 extends parallel to the pin body 26. In this respect, the central portion 50 can be located, by one or both of the general configuration of the coupling assembly 24 or the intended orientation of assembly within the base 12, toward a front side 52 of the base 12. In one aspect, this arrangement can accommodate a specific upward rotational movement of the mixing head 20 in the pitch direction P that corresponds with the configuration of the mixing head 20 and the base 12 by way of the depicted upper mounting area 16 and the positioning of the coupling assembly 24 with respect to the upper mounting area 16 and the tongue 22. In particular during the rotation of the mixing head 20 from the lowered position shown in FIG. 1, as well as in cross-section in FIG. 5, to the raised position shown in FIGS. 2 and 6, the tongue 22 can rotate in a rearward direction with respect to the base 12. As shown, this rearward movement includes movement of the tongue 22 to a position in which it extends outwardly with respect to a rear surface 53 of the base 12, including by way of the opening 18 extending from the upper surface 54 of the base 12 to a portion of the rear surface 54 within the mounting area 16. In one respect, this movement accommodates a wider opening of the mixing head 20 with respect to the base 12, including in the area of the mixing bowl 36 and is achieved by the depicted location of the pin body 26. To achieve this positioning and movement, the central portion 50 of the frame body 34 is positioned, as discussed above, toward the front surface 52 of the base 12 and, more particularly, on a corresponding front side 52 of the tongue 22 (i.e., between the tongue 22 and the front surface 52) to accommodate this rearward rotation of the tongue 22. In a further variation, the pivot frame 30 can comprise separate lateral portions that include the respective support receptacles 32a, 32b and configured to accommodate the attachment features for coupling the portions of the pivot frame 30 to the base 14, as discussed further below. In such an arrangement, wherein it is to be appreciated that the central portion 50 is omitted or otherwise divided, the cylindrical segments 46 can define channels or other features that interact with the cylindrical openings 48 (including during over molding of the pivot frame 30 portions) to retain the pivot frame on the pin body 26.

As shown in FIGS. 5 and 6, the upper surface 54 of the base 12 is generally convex and is generally concentric about the location at which the pin body 26 is positioned such that the shape of the upper surface 54 generally follows the path of the mixing head 20 during rearward rotation in the pitch direction P. In this manner, a lower surface 56 of the mixing head 20, from which the tongue 22 extends, is concave to match the profile of the upper surface 54. It is noted, however, that the complementary configuration of the upper surface 54 of the base 12 and the lower surface 56 of the mixing head 20 may not be used for articulation or support of the mixing head 20 on the base 12. Rather, the mixing head 20 may be primarily supported on the base 12 by the coupling assembly 24, with only the adjustable screw 58 received in tongue 22 and the lower end 60 of tongue 22 providing additional support for the mixing head 20 against the base 12 when the mixing head 20 is, respectively, in the lowered position (FIG. 5) or the raised position (FIG. 6). Accordingly, the coupling assembly 24, as well as the fixation points with the mixing head 20 and, particularly, the base 12 may be configured to support the weight of the mixing head 20 on the base 12 (with the lower surface 56 of mixing head 20 spaced from the upper surface 54 of base 12.

In one aspect, the base can define a pair of cheeks 62 within the mounting area 16 and disposed on opposite lateral sides of the opening 18. The cheeks 62 can be configured to incorporate respective coupling bodies 64 within the interior 14 of the base 12. In this respect, it is noted that the base 12 can be configured as a generally hollow structure with an open bottom end 66, such that the interior 14 can be accessed therethrough. This configuration can provide for insertion, alignment, and fixation of the coupling assembly 24 with the base 12 and the mixing head 20, as discussed further below. In this respect, the direction of the coupling bodies 64 toward the open bottom end 66 allows for access to the pivot frame 30 for fixation thereof to the base 12. As illustrated in FIG. 4, the pivot frame 30 can be secured to the base 12 by engaging a plurality of screws 68 that pass through and capture the frame body 34 against the coupling bodies 64 of the cheeks 62 with which the screws 68 are threadedly engaged. The frame body 34 can define a plurality of through holes 70 sized to receive respective ones of the screws 68. In a similar manner, the pin body 26 can be secured to the mixing head 20 by at least one screw 68 or, in the illustrated implementation, a pair of screws 68 extending through additional through holes 72 the pin body 26 and engaging with the tongue 22 of the mixing head 20.

In one aspect, the through holes 70 can be oversized relative to the screws 68 and the accepted clearance therefore such that the through holes 70 can accommodate a variation between the manufacturing tolerances associated with the base 12 and the mixing head 20, including with respect to both their individual features, as well as the fit therebetween, and the tolerance associated with the pin body 26 and the frame body 34. As noted above, the tolerance between the pin body 26 and the pivot frame 30 is, essentially, zero. While there are further tolerances resulting, at least, from the configuration of pivot frame 30 and the through holes 70 and 72, such tolerances may still be lower than those associated with the base 12 and the mixing head 20. Accordingly, the sizing of the through holes 70 can accommodate such a variation in tolerances by being oversized by an amount generally corresponding with the tolerance difference such that the screws 68 can reach respective threaded holes 80 in the coupling bodies 64 regardless of alignment variations between the components. In an alternative arrangement, the tongue 22 and the mounting area 16 can be configured to accommodate tolerance variations. To assist in proper location of the coupling assembly 24 with the base 12, the pivot frame 30 can include at least one alignment protrusion 74, and in the depicted implementation, two alignment protrusions 74, configured for receipt in a mating alignment with a respective one of the first and second cheeks 62, including within an alignment hole 76 in the coupling bodies 64 prior to assembly of the screws 68. In a similar manner, the tongue 22 can define a channel 78 that can receive the pin body 26 for proper alignment therebetween. As shown, the pin body 26 can include a center hole 82 that is configured to receive an alignment dowel 84 therein in a press-fit arrangement. The tongue 22 includes an alignment hole 87 (FIG. 6) therein that receives the alignment dowel 84 during assembly, the alignment dowel 84 is aligned with the alignment hole 87 to locate the mixing head 20 laterally about the center of hinge pin 26, which corresponds with the lateral center of the coupling assembly 24. With the above-described alignment of the alignment protrusions 74 with the alignment holes 76 in the cheeks 62 the mixing head 20 is laterally aligned with the base 14. Additionally, during manufacture of the coupling assembly 24, center hole 82 can be used to locate the pin body 26 in an appropriately-configured mold such that the over molded pivot frame 30 (including the respective through holes 70 and alignment protrusions 72 will be properly positioned with respect to the corresponding features in the pin body 26.

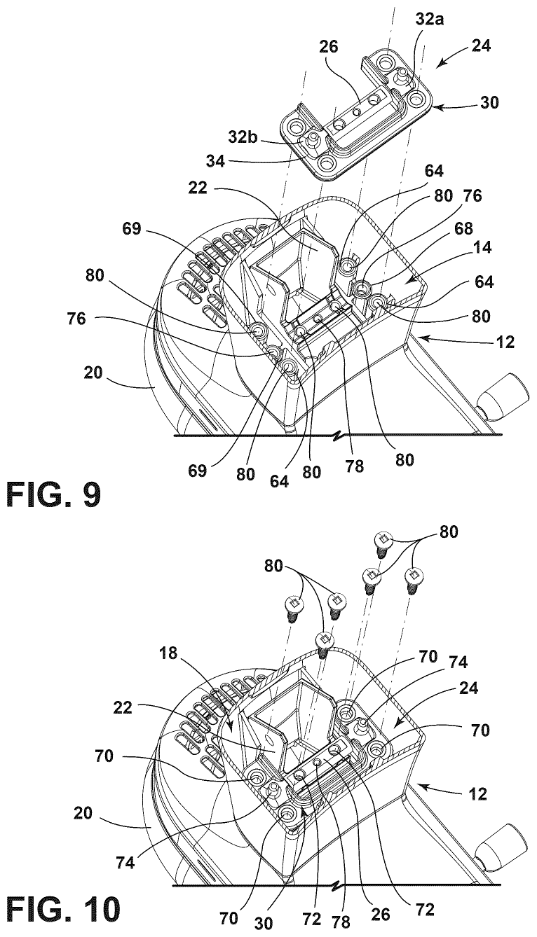

In a further aspect of the disclosure, a method for assembling the stand mixer 10, as described above, includes aligning the mixing head 20 over the upper mounting area 16 of the 12. As shown in FIG. 9, this alignment is such that the mounting tongue 22 of the mixing head 20 extends through the opening 18 in the mounting area 16. In one aspect, this alignment can be achieved using a fixture that maintains this alignment, including with the lower surface 56 of the mixing head 20 and the upper surface 54 of the base 12 in the spaced relationship discussed above. In a further aspect, such a fixture can maintain this position by retaining the mixing head 20 and the base 12 in the inverted arrangement shown in FIG. 9. In this respect, it is to be understood that the description of the mixing head 20 being above the upper mounting area 16 may be made with respect to the ultimate configuration of the stand mixer 10, as shown in FIG. 1, regardless of the orientation of the fixture. After the alignment of the mixing head 20 and the base 12, the coupling assembly 24, as described above, is assembled within the interior 14 of the base 12, including through the open bottom end 66 thereof. As discussed above, this alignment is such that the pin body 26 is aligned with the tongue 22 of the mixing head 20, including within the channel 78 described above, and the pivot frame 30 is aligned and in contact with the coupling bodies 64.

As shown in FIG. 10, the mixing head 20 is then secured to the base 12 by fixing the frame body 34 of the pivot frame 30 to the base 12 along the interior 14 thereof and fixing the pin body 26 to the mounting tongue 22 of the mixing head 20. As discussed above, this can be done by assembling screws 68 through respective through holes 70, 72 in the frame body 34 and the pin body 26 to engage with threaded holes 80 in the coupling bodies 64 and the tongue 22 and tightening such screws 68 to fix the frame body 34 and the pin body 26 with the base 12 and the tongue 22, respectively. In a variation, the coupling assembly 24 can be temporarily retained in the desired position for fixation with the base 12 and the mixing head 20 (including by the fixture used to align the mixing head 20 with the base 12) such that the threaded holes 80 can be drilled into the coupling bodies 64 and the tongue 22 in locations that directly correspond with the locations of the respective through holes 70, 72. In this respect, the screws 68 can be self-tapping such that the threaded holes 80 can be drilled as straight holes and made into the desired threaded holes 80 by assembly of the screws 68 therewith. After such assembly, the coupling assembly 24 pivotably couples the mixing head 20 to the base 12 with the mixing head 20 being rotatable on the base 12 in the pitch direction P, as discussed above, between the lowered position and the raised position with respect to the base 12.

In a further aspect, the method can further include fabricating the coupling assembly 24 by over molding the frame body 34 out of a plastic material with respect to the pin body 26, which can consist essentially of metal, as discussed above. In particular, the pin body 26 can be machined from the metal material to define the cylindrical segments 46 having the desired external diameter D1 on the first and second ends 28a, 28b of the pin body 26. The pin body 26 can then be placed in a mold specifically adapted to retain the pin body 26 within the mold cavity and to form the pivot frame 30 thereover. In particular, the mold is configured to receive a molten plastic material by injection and to, thereby, define the support receptacles 32a, 32b with the respective cylindrical cavities 48 extending over the cylindrical segments 46 of the pin body 26. As discussed above, the over molding of the frame body 34 defines the cylindrical cavities 48 with internal diameters D2 defined by the external diameters D1 of the cylindrical segments 46 such that the first and second ends 28a, 28b are closely received in the first and second support receptacles 32a, 32b.

The invention disclosed herein is further summarized in the following paragraphs and is further characterized by combinations of any and all of the various aspects described therein.

According to another aspect of the present disclosure, a stand mixer includes a base configured for resting on a surface and defining an interior and an upper mounting area with an opening to the interior and a mixing head being supported over the upper mounting area of the base and defining a mounting tongue extending through the opening in the mounting area to the interior of the base. The stand mixer further includes a coupling assembly including a pin body extending between opposite first and second ends and a pivot frame including first and second support receptacles respectively receiving the first and second ends of the pin body and a frame body connecting the first and second support receptacles. The frame body is secured to the base along the interior thereof, and the pin body is secured to the mounting tongue of the mixing head to pivotably couple the mixing head to the base with the mixing head being rotatable on the base between a lowered, use position and a raised, non-use position with respect to the base.

In the stand mixer of ¶ [0040], the pin body can be fixed with respect to the tongue of the mixing head, the frame body can be fixed within the interior of the base, and the pin body can be rotatably coupled with the frame body such that mixing head is rotatable on the base.

In the stand mixer of ¶¶ [0040] or [0041], the first and second ends of the pin body can be defined by respective cylindrical segments having a first external diameter, and the first and second support receptacles can define respective cylindrical openings having a first internal diameter equal to the first external diameter such that the first and second ends are closely received in the first and second support receptacles.

In the stand mixer of ¶ [0042], the pin body can consist essentially of a metal, and the frame body can comprise a plastic that is over molded with respect to the pin body to define the first internal diameter by way of the first external diameter.

In the stand mixer of any of ¶¶ [0040] to [0043], the frame body can be a unitary structure including a central portion extending parallel to the pin body.

In the stand mixer of ¶ [0044], the tongue can rotate in a rearward direction with respect to the base during movement of the mixing head between the lowered position and the raised position, and the central portion of the frame body can be positioned on a front side of the tongue of the mixing head to accommodate the rearward rotation of the tongue.

In the stand mixer of any of ¶ [0040] to [0045], the base can define first and second cheeks within the mounting area and disposed on opposite lateral sides of the opening, and the frame body can be secured to the base by a plurality of screws respectively extending through the frame body and engaging with one of the first and second cheeks.

In the stand mixer of ¶ [0046], the frame body can define a plurality of through holes sized to receive respective ones of the plurality of screws and to accommodate a tolerance variation between a first tolerance associated with the base and the mixing head and a second tolerance associated with the pin body and the frame body.

In the stand mixer of either of ¶¶ [0046] or [0047], the frame body can include at least one alignment protrusion configured for receipt in a mating alignment with a respective one of the first and second cheeks prior to assembly of the plurality of screws.

In the stand mixer of any of ¶ [0040] to [0048], the pin body can be secured to the mixing head by at least one screw extending through the pin body and engaging with the tongue of the mixing head.

In the stand mixer of any of ¶¶ [0040] to [0049], the pin body can be fixed with respect to the tongue of the mixing head, the frame body can be fixed within the interior of the base, and the pin body can be rotatably coupled with the frame body such that mixing head is rotatable on the base.

According to yet another aspect, a coupling assembly for a stand mixer includes a pin body extending between opposite first and second ends and being fixedly securable with a tongue of a mixing head of the stand mixer. The coupling assembly further includes a pivot frame having a frame body being securable to a base of the stand mixer within an interior thereof and first and second support receptacles respectively receiving the first and second ends of the pin body such that the pin body is rotatable with respect to the pivot frame. The frame body connects the first and second support receptacles such that the mixing head is rotatable on the base between a lowered, use position and a raised, non-use position with respect to the base.

In the coupling assembly of ¶ [0051], the pin can be fixedly securable with the tongue of the mixing head when received through an opening in an upper mounting area of the base with the tongue rotating in a rearward direction with respect to the base during movement of the mixing head between the lowered position and the raised position, and the central portion of the frame body is positionable on a front side of the tongue of the mixing head to accommodate the rearward rotation of the tongue.

In the coupling assembly of ¶¶ [0051] or [0052], the pin body can be rotatably coupled with the frame body such that mixing head is rotatable on the base when the pin body is fixed with respect to the tongue of the mixing head and the frame body is fixed within the interior of the base.

In the coupling assembly of any of ¶¶ [0051] to [0053], the first and second ends of the pin body can be defined by respective cylindrical segments having a first external diameter, and the first and second support receptacles can define respective cylindrical openings having a first internal diameter equal to the first external diameter such that the first and second ends are closely received in the first and second support receptacles.

In the coupling assembly of ¶ [0054], the pin body can consist essentially of a metal, and the frame body can comprise a plastic that is over molded with respect to the pin body to define the first internal diameter by way of the first external diameter.

In the coupling assembly of any of ¶¶ [0051] to [0055], the frame body can be a unitary structure including a central portion extending parallel to the pin body.

In the coupling assembly of any of ¶¶ [0051] to [0056], wherein the frame body can define a plurality of first through holes for securing the frame body to the base by a first plurality of screws respectively extending through the frame body and engaging with respective portions of the interior of the base, the pin body can define a plurality of second through holes for securing the mixing head to the pin body by at least one second screw extending through the pin body and engaging with the tongue of the mixing head, and the first through holes can be sized to receive respective ones of the plurality of first screws so as to accommodate a variation between a first tolerance associated with the base and the mixing head and a second tolerance associated with the pin body and the frame body.

In the coupling assembly of ¶ [0057], the frame body can include at least one alignment protrusion configured for aligning the frame body relative to the base prior to assembly of the plurality of first screws.

According to yet another aspect, a method for assembling a stand mixer includes aligning a mixing head over an upper mounting area of a base configured for resting on a surface and defining an interior. The mounting area includes an opening to the interior, and the mixing head defines a mounting tongue that through the opening in the mounting area. The method further includes positioning a coupling assembly within the interior of the base. The coupling assembly includes a pin body extending between opposite first and second ends and a pivot frame including first and second support receptacles respectively receiving the first and second ends of the pin body and a frame body connecting the first and second support receptacles. The method further includes attaching the mixing head to the base by fixing the frame body to the base along the interior thereof and fixing the pin body to the mounting tongue of the mixing head. The pin body is rotatable within the first and second support receptacles of the pivot frame to pivotably couple the mixing head to the base with the mixing head being rotatable on the base between a lowered, use position and a raised, non-use position with respect to the base.

The method of ¶ [0059], can further include fabricating the coupling assembly by over molding the frame body out of a plastic material with respect to the pin body, which can consist essentially of metal, the frame body defining respective cylindrical cavities extending over respective cylindrical segments having a first diameter on the first and second ends of the pin body, the over molding of the frame body defining the cylindrical cavities with first internal diameters defined by the external diameters of the cylindrical segments such that the first and second ends are closely received in the first and second support receptacles.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A stand mixer comprising:
a base configured for resting on a surface and defining an interior and an upper mounting area with an opening to the interior;
a mixing head being supported over the upper mounting area of the base and defining a mounting tongue extending through the opening in the mounting area to the interior of the base; and
a coupling assembly including a pin body extending between opposite first and second ends and a pivot frame including first and second support receptacles respectively receiving the first and second ends of the pin body and a frame body connecting the first and second support receptacles, the frame body being secured to the base along the interior thereof, and the pin body being secured to the mounting tongue of the mixing head to pivotably couple the mixing head to the base with the mixing head being rotatable on the base between a lowered, use position and a raised, non-use position with respect to the base.

2. The stand mixer of claim 1, wherein:
the pin body is fixed with respect to the tongue of the mixing head;
the frame body is fixed within the interior of the base; and
the pin body is rotatably coupled with the frame body such that mixing head is rotatable on the base.

3. The stand mixer of claim 1, wherein:
the first and second ends of the pin body are defined by respective cylindrical segments having a first external diameter; and
the first and second support receptacles define respective cylindrical openings having a first internal diameter equal to the first external diameter such that the first and second ends are closely received in the first and second support receptacles.

4. The stand mixer of claim 3, wherein:
the pin body consists essentially of a metal; and
the frame body comprises a plastic that is over molded with respect to the pin body to define the first internal diameter by way of the first external diameter.

5. The stand mixer of claim 1, wherein the frame body is a unitary structure including a central portion extending parallel to the pin body.

6. The stand mixer of claim 5, wherein:
the tongue rotates in a rearward direction with respect to the base during movement of the mixing head between the lowered position and the raised position; and
the central portion of the frame body is positioned on a front side of the tongue of the mixing head to accommodate the rearward rotation of the tongue.

7. The stand mixer of claim 1, wherein:
the base defines first and second cheeks within the mounting area and disposed on opposite lateral sides of the opening; and
the frame body is secured to the base by a plurality of screws respectively extending through the frame body and engaging with one of the first and second cheeks.

8. The stand mixer of claim 7, wherein the frame body defines a plurality of through holes sized to receive respective ones of the plurality of screws such to accommodate a tolerance variation between a first tolerance associated with the base and the mixing head and a second tolerance associated with the pin body and the frame body.

9. The stand mixer of claim 7, wherein the frame body includes at least one alignment protrusion configured for receipt in a mating alignment in a respective one of the first and second cheeks prior to assembly of the plurality of screws.

10. The stand mixer of claim 1, wherein the pin body is secured to the mixing head by at least one screw extending through the pin body and engaging with the tongue of the mixing head.

11. A coupling assembly for a stand mixer, comprising:
a pin body extending between opposite first and second ends and being fixedly securable with a tongue of a mixing head of the stand mixer; and
a pivot frame including:
a frame body being securable to a base of the stand mixer within an interior thereof; and
first and second support receptacles respectively receiving the first and second ends of the pin body such that the pin body is rotatable with respect to the pivot frame, the frame body connecting the first and second support receptacles such that the mixing head is rotatable on the base between a lowered, use position and a raised, non-use position with respect to the base.

12. The coupling assembly of claim 11, wherein:
the pin is fixedly securable with the tongue of the mixing head when received through an opening in an upper mounting area of the base with the tongue rotating in a rearward direction with respect to the base during movement of the mixing head between the lowered position and the raised position; and
the central portion of the frame body is positionable on a front side of the tongue of the mixing head to accommodate a rearward rotation of the tongue.

13. The coupling assembly of claim 11, wherein the pin body is rotatably coupled with the frame body such that mixing head is rotatable on the base when the pin body is fixed with respect to the tongue of the mixing head and the frame body is fixed within the interior of the base.

14. The coupling assembly of claim 11, wherein:
the first and second ends of the pin body are defined by respective cylindrical segments having a first external diameter; and
the first and second support receptacles define respective cylindrical openings having a first internal diameter equal to the first external diameter such that the first and second ends are closely received in the first and second support receptacles.

15. The coupling assembly of claim 14, wherein:
the pin body consists essentially of a metal; and
the frame body comprises a plastic that is over molded with respect to the pin body to define the first internal diameter by way of the first external diameter.

16. The coupling assembly of claim 11, wherein the frame body is a unitary structure including a central portion extending parallel to the pin body.

17. The coupling assembly of claim 11, wherein:
the frame body defines a plurality of first through holes for securing the frame body to the base by a first plurality of screws respectively extending through the frame body and engaging with respective portions of the interior of the base;
the pin body defines a plurality of second through holes for securing the mixing head to the pin body by at least one second screw extending through the pin body and engaging with the tongue of the mixing head; and
the first through holes are sized to receive respective ones of the plurality of first screws so as to accommodate a variation between a first tolerance associated with the base and the mixing head and a second tolerance associated with the pin body and the frame body.

18. The coupling assembly of claim 17, wherein the frame body includes at least one alignment protrusion configured for aligning the frame body relative to the base prior to assembly of the plurality of first screws.

19. A method for assembling a stand mixer, comprising:
aligning a mixing head over an upper mounting area of a base configured for resting on a surface and defining an interior, the mounting area including an opening to the interior, and the mixing head defining a mounting tongue, wherein the tongue extends through the opening in the mounting area;
positioning a coupling assembly within the interior of the base, the coupling assembly including a pin body extending between opposite first and second ends and a pivot frame including first and second support receptacles respectively receiving the first and second ends of the pin body and a frame body connecting the first and second support receptacles;
attaching the mixing head to the base by fixing the frame body to the base along the interior thereof and fixing the pin body to the mounting tongue of the mixing head, wherein the pin body is rotatable within the first and second support receptacles of the pivot frame to pivotably couple the mixing head to the base with the mixing head being rotatable on the base between a lowered, use position and a raised, non-use position with respect to the base.

20. The method of claim 19, further including fabricating the coupling assembly by over molding the frame body out of a plastic material with respect to the pin body, which consists essentially of metal, the frame body defining respective cylindrical cavities extending over respective cylindrical segments having a first diameter on the first and second ends of the pin body, the over molding of the frame body defining the cylindrical cavities with first internal diameters defined by the external diameters of the cylindrical segments such that the first and second ends are closely received in the first and second support receptacles.
